(19) United States
(12) Patent Application Publication
(10) Pub. No.: US 2026/0206738 A1
(43) Pub. Date: Jul. 23, 2026

(54) System and Method for Selectively Applying Electrostatically Charged Herbicides to Target Weeds in an Agricultural Field

(71) Applicant: Centure Applications LTD, Tel Aviv-Yafo (IL)

(72) Inventors: Itzhak Khait, Vaughan (CA); Eran Beck, Tel Aviv-Yafo (IL)

(21) Appl. No.: 19/457,668

(22) Filed: Jan. 23, 2026

Related U.S. Application Data
(60) Provisional application No. 63/748,542, filed on Jan. 23, 2025.

(51) Int. Cl. A01M 7/00; B05B 5/08

(52) U.S. Cl. CPC A01M 7/0089; A01M 7/0042; B05B 5/085

(57) ABSTRACT

An agricultural sprayer includes a spray boom attached to an agricultural vehicle, broadcast nozzles configured to spray a residual herbicide onto an agricultural field, and selective-spot spray nozzles configured to spray a non-residual herbicide. Broadcast chargers are electrically coupled to the broadcast nozzles to cause the residual herbicide to have an electrostatic charge such that charged droplets are applied to a target weed. Cameras capture images of the agricultural field. A computing device detects the target weed using a trained machine learning model, activates the broadcast nozzles to spray charged droplets onto the agricultural field including the target weed, and activates the selective-spot spray nozzles to selectively spray non-residual herbicide droplets that are electrostatically attracted to the charged droplets on the target weed.

### CROSS-REFERENCE TO RELATED APPLICATIONS

This application claims priority to U.S. Provisional Application No. 63/748,542, titled “System And Method For Selectively Applying Electrostatically Charged Herbicides To Target Weeds In An Agricultural Field,” filed on Jan. 23, 2025, which is hereby incorporated by reference.

### TECHNICAL FIELD

This application relates generally to agricultural spray systems.

### BACKGROUND

Agricultural spray systems are widely used to apply herbicides, pesticides, and other agricultural products to fields during farming operations. These systems typically include spray booms mounted on agricultural vehicles such as tractors, which carry the spray boom across the field while dispensing liquid agricultural products through nozzles arranged along the boom.

Some agricultural spray systems include broadcast nozzles that apply a general-application agricultural product uniformly across an agricultural field. Such broadcast application can result in the spraying of herbicides to areas where weeds are not present, leading to inefficient use of agricultural chemicals and potential environmental concerns.

More advanced agricultural spray systems have incorporated selective-spot spray capabilities, where specific agricultural products are selectively applied to target weeds detected in the agricultural field. These systems may use imaging sensors and machine learning models to detect weeds and activate selective-spot spray nozzles to treat the detected weeds. While such selective spraying approaches can reduce the overall amount of herbicide applied to a field, challenges remain in ensuring that the applied herbicides effectively reach and adhere to the target weeds.

Herbicide drift and off-target application continue to present challenges in agricultural spraying operations. When herbicide droplets are sprayed from nozzles, they may be affected by wind, gravity, and other environmental factors that can cause the droplets to deviate from their intended targets. This can result in reduced herbicide effectiveness on target weeds and unintended application to non-target areas of the field.

It would be desirable to improve the effectiveness of targeted application of agricultural products to an agricultural field.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to an agricultural sprayer, comprising a spray boom configured to be attached to an agricultural vehicle; one or more broadcast nozzles mounted on the spray boom and configured to spray a residual herbicide onto an agricultural field; one or more selective-spot spray nozzles mounted on the spray boom and configured to spray a non-residual herbicide onto the agricultural field; one or more broadcast chargers electrically coupled to the one or more broadcast nozzles, the one or more broadcast chargers configured to cause the residual herbicide sprayed by the one or more broadcast nozzles to have an electrostatic charge such that charged broadcast droplets are applied to a target weed in the agricultural field; one or more cameras mounted on the spray boom and configured to capture images of the agricultural field; and a computing device configured to: receive the images from the one or more cameras; detect the target weed in one or more of the images using a trained machine learning model; activate the one or more broadcast nozzles to spray the charged broadcast droplets onto at least a region of the agricultural field that includes the target weed; and selectively activate, in response to detecting the target weed, the one or more selective-spot spray nozzles to spray droplets of the non-residual herbicide onto the target weed, wherein the droplets of the non-residual herbicide are electrostatically attracted to the charged broadcast droplets on the target weed.

In one or more embodiments, the one or more broadcast nozzles are located closer to a target spray region of the agricultural field than the one or more selective-spot spray nozzles such that the charged broadcast droplets reach the target weed before the droplets of the non-residual herbicide reach the target weed. In one or more embodiments, the charged broadcast droplets have a positive polarity. In one or more embodiments, the charged broadcast droplets have a negative polarity.

In one or more embodiments, the agricultural sprayer further comprises one or more selective-spot spray chargers electrically coupled to the one or more selective-spot spray nozzles, the one or more selective-spot spray chargers configured to cause the non-residual herbicide sprayed by the one or more selective-spot spray nozzles to have an electrostatic charge such that charged selective-spot spray droplets are applied to the target weed, wherein the charged selective-spot spray droplets are electrostatically attracted to the charged broadcast droplets on the target weed. In one or more embodiments, the charged broadcast droplets and the charged selective-spot spray droplets have opposite polarities. In one or more embodiments, the charged broadcast droplets have a positive polarity and the charged selective-spot spray droplets have a negative polarity. In one or more embodiments, the charged broadcast droplets have a negative polarity and the charged selective-spot spray droplets have a positive polarity.

In one or more embodiments, the residual herbicide comprises s-metolachlor, acetochlor, pyroxasulfone, atrazine, and/or mesotrione. In one or more embodiments, the non-residual herbicide comprises glyphosate, glufosinate, and/or 2,4-dichlorophenoxyacetic acid.

In one or more embodiments, the computing device is further configured to activate the one or more broadcast nozzles to spray the residual herbicide onto regions of the agricultural field where no target weeds are detected, and wherein the one or more broadcast chargers do not electrostatically charge the residual herbicide applied to the regions of the agricultural field where no target weeds are detected.

Another aspect of the invention is directed to a method for spraying an agricultural field, comprising capturing images of respective regions of the agricultural field using one or more cameras mounted on a spray boom; detecting a target weed in one or more of the images using a trained machine learning model; broadcast spraying at least the respective regions of the agricultural field in which the target weed is detected, with a residual herbicide using one or more broadcast nozzles mounted on the spray boom, wherein one or more broadcast chargers electrostatically charge the residual herbicide such that charged broadcast droplets are applied to the target weed; and selective spot spraying the respective regions of the agricultural field in which the target weed is detected with a non-residual herbicide using one or more selective-spot spray nozzles mounted on the spray boom, wherein droplets of the non-residual herbicide are electrostatically attracted to the charged broadcast droplets on the target weed.

In one or more embodiments, the one or more broadcast nozzles are located closer to a target spray region of the agricultural field than the one or more selective-spot spray nozzles such that the charged broadcast droplets reach the target weed before the droplets of the non-residual herbicide reach the target weed.

In one or more embodiments, the method further comprises electrostatically charging the non-residual herbicide using one or more selective-spot spray chargers such that charged selective-spot spray droplets are applied to the target weed, wherein the charged selective-spot spray droplets are electrostatically attracted to the charged broadcast droplets on the target weed. In one or more embodiments, the charged broadcast droplets and the charged selective-spot spray droplets have opposite polarities.

In one or more embodiments, the method further comprises broadcast spraying regions of the agricultural field in which no target weeds are detected with the residual herbicide using the one or more broadcast nozzles, wherein the one or more broadcast chargers do not electrostatically charge the residual herbicide applied to the regions of the agricultural field in which no target weeds are detected. In one or more embodiments, the method further comprises broadcast spraying neighboring regions adjacent to the respective regions in which the target weed is detected at an increased application rate compared to a default application rate.

Another aspect of the invention is directed to a non-transitory computer-readable medium storing computer-readable instructions that, when executed by one or more processors, cause the one or more processors to receive images of an agricultural field from one or more cameras mounted on a spray boom; detect a target weed in one or more of the images using a trained machine learning model; activate the one or more broadcast nozzles to spray the charged broadcast droplets onto at least a region of the agricultural field that includes the target weed, wherein the charged broadcast droplets are electrostatically charged by one or more broadcast chargers electrically coupled to the one or more broadcast nozzles; and selectively activate, in response to detecting the target weed, one or more selective-spot spray nozzles mounted on the spray boom to spray droplets of a non-residual herbicide onto the target weed, wherein the droplets of the non-residual herbicide are electrostatically attracted to the charged broadcast droplets on the target weed.

In one or more embodiments, the computer-readable instructions, when executed by one or more processors, further cause the one or more processors to activate one or more selective-spot spray chargers electrically coupled to the one or more selective-spot spray nozzles to electrostatically charge the non-residual herbicide such that charged selective-spot spray droplets are applied to the target weed, wherein the charged selective-spot spray droplets are electrostatically attracted to the charged broadcast droplets on the target weed, and wherein the charged broadcast droplets and the charged selective-spot spray droplets have opposite polarities.

In one or more embodiments, the computer-readable instructions, when executed by one or more processors, further cause the one or more processors to activate the one or more broadcast nozzles to spray the residual herbicide onto regions of the agricultural field where no target weeds are detected, and wherein the one or more broadcast chargers do not electrostatically charge the residual herbicide applied to the regions of the agricultural field where no target weeds are detected.

### BRIEF DESCRIPTION OF THE DRAWINGS

For a fuller understanding of the nature and advantages of the concepts disclosed herein, reference is made to the detailed description of example embodiments and the accompanying drawings.

FIG. 1 is an isometric view of a dual-sprayer system according to one or more embodiments.

FIG. 2 is a side view of a dual-sprayer system according to one or more embodiments.

FIG. 3 is a block diagram of a spray system for selectively applying a treatment to a target region according to one or more embodiments.

FIG. 4 is a simplified block diagram of fluid and electrical circuits for a sprayer system according to one or more embodiments.

FIGS. 5A and 5B illustrate first and second stages, respectively, of a time sequence of spraying using broadcast nozzles, selective-spot spray nozzles, and a broadcast charger(s) according to one or more embodiments.

FIG. 6 is a simplified block diagram of fluid and electrical circuits for a sprayer system according to one or more alternative embodiments.

FIGS. 7A and 7B illustrate first and second stages, respectively, of a time sequence of spraying using broadcast nozzles, selective-spot spray nozzles, a broadcast charger(s), and a selective-spot spray charger(s) according to one or more embodiments.

FIG. 8 is a flow chart of a method for spraying an agricultural field using charged broadcast droplets according to one or more embodiments.

FIG. 9 is a flow chart of a method for spraying an agricultural field using charged broadcast droplets according to one or more embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

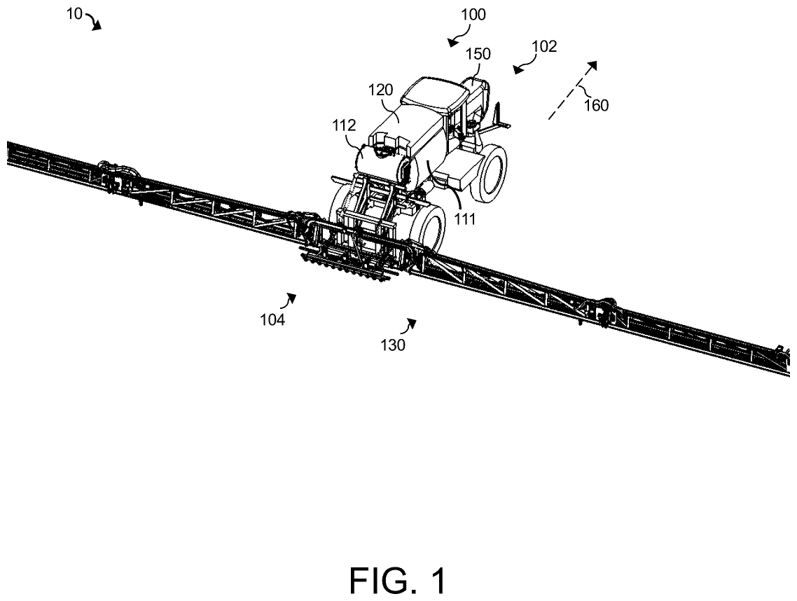

FIG. 1 is an isometric view of a dual-sprayer system 10 according to one or more embodiments. The dual-sprayer system 10 includes an agricultural vehicle 100, an optional broadcast tank 111, an optional selective-spot spray (SSP) tank 112, a rinse tank 120, and a spray boom 130. The agricultural vehicle 100 includes a front 102, a back 104, and an engine 150. The spray boom 130 may be attached to the back 104 of the agricultural vehicle 100 such that the agricultural vehicle 100 pulls the spray boom 130 as the agricultural vehicle 100 drives forward in a direction 160.

The broadcast tank 111 may be mounted on the agricultural vehicle 100 and may be configured to hold one or more general-application herbicides to be sprayed broadly onto an agricultural field using the spray boom 130. In some cases, the broadcast tank 111 holds one or more residual herbicides that persist in the soil for an extended period, controlling weeds that germinate after application. Examples of residual herbicides include s-metolachlor, acetochlor, pyroxasulfone, atrazine, and/or mesotrione. In some cases, the broadcast tank 111 may be fluidly coupled to a direct-injection system that injects residual herbicides into one or more first fluid lines to create a residual-herbicide/water mixture having an appropriate concentration of residual herbicides to apply onto the agricultural field, as an alternative to holding pre-mixed herbicides.

The SSP tank 112 may be mounted on the agricultural vehicle 100 and may be configured to hold one or more target-application liquid herbicides designed to target one or more weeds or other target features in the agricultural field. In some cases, the SSP tank 112 holds one or more non-residual herbicides. Examples of non-residual herbicides include glyphosate, glufosinate, and/or 2,4-dichlorophenoxyacetic acid (commonly referred to as 2,4-D). One or more second fluid lines may fluidly couple the SSP tank 112 to one or more SSP nozzles on the spray boom 130. In some cases, the second fluid line may be fluidly coupled to the broadcast tank 111 and to a direct-injection system that injects non-residual herbicides into the second fluid line to create a mixture of residual and non-residual herbicides. In some cases, the second fluid line may be fluidly coupled to the rinse tank 120 and to a direct-injection system that injects one or more non-residual herbicides into the second fluid line to create a specific liquid herbicide mixture having an appropriate concentration.

The specific liquid herbicide(s) in the SSP tank 112 are selectively sprayed using the SSP nozzle(s) in response to imaging of the agricultural field and analysis/detection of weeds and/or target features by one or more trained machine learning models. Valve(s) coupled to the SSP nozzle(s) can be opened and closed to selectively spray the detected weeds. When the valve(s) is/are opened, the valve(s) can be repeatedly opened and closed at a frequency and at a variable duty cycle. The duty cycle can be varied according to the speed of the agricultural vehicle 100 and/or the height of the spray boom 130 to maintain a uniform or substantially uniform (e.g., within about 5% to about 10%) application rate of the specific liquid agricultural product(s).

The rinse tank 120 may be positioned on the agricultural vehicle 100 and may be fluidly coupled to the broadcast tank 111 and/or the SSP tank 112 for rinsing and/or direct-injection. Water or another liquid stored in the rinse tank 120 may be used to rinse the broadcast tank 111 and the SSP tank 112 after each tank is emptied. The rinse tank 120 can be optional in some embodiments. In one or more embodiments, the rinse tank 120 can be fluidly coupled to the first fluid line(s) and/or to the second fluid line(s).

The engine 150 for the agricultural vehicle 100 can be replaced with a motor when the agricultural vehicle 100 is electric or can include both an engine and a motor when the agricultural vehicle 100 is a hybrid vehicle. In any case, the agricultural vehicle 100 includes a mechanical drive system that powers the agricultural vehicle 100 and the wheels.

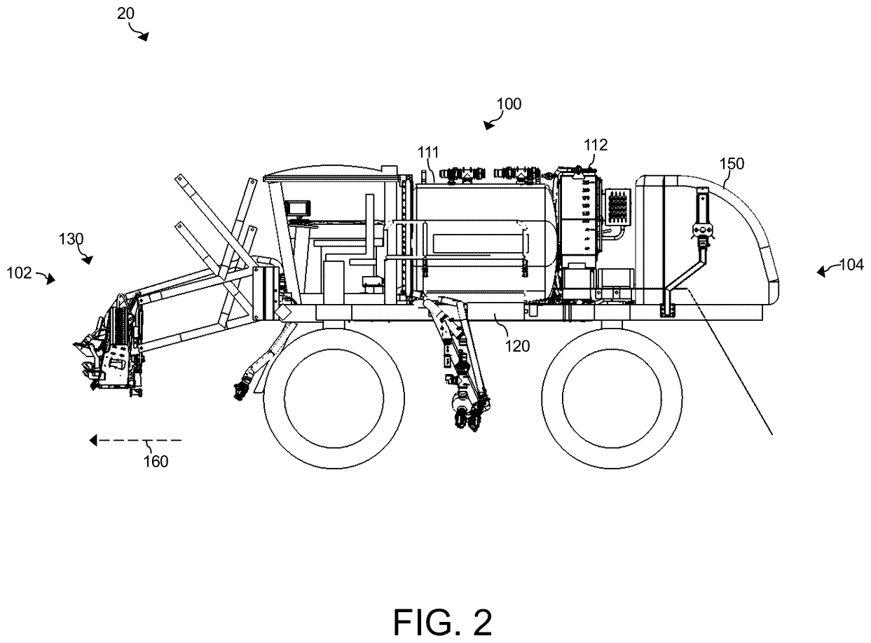

FIG. 2 is a side view of a dual-sprayer system 20 according to one or more embodiments. The dual-sprayer system 20 is the same (or substantially the same) as system 10 (FIG. 1) except for the locations of the optional broadcast tank 111, the optional SSP tank 112, and the optional rinse tank 120 and the configuration/location of the spray boom 130.

The dual-sprayer system 20 includes the agricultural vehicle 100 with a front 102 and a back 104. The spray boom 130 is attached to the front 102 of the agricultural vehicle 100 in this configuration, such that the agricultural vehicle 100 pushes the spray boom 130 as the agricultural vehicle 100 drives forward in the direction 160.

The broadcast tank 111 and the SSP tank 112 may be mounted on the agricultural vehicle 100. The broadcast tank 111 may be configured to hold one or more general-application herbicides to be sprayed broadly onto an agricultural field using the spray boom 130. The SSP tank 112 may be configured to hold one or more target-application or specific liquid herbicides designed to target one or more weeds or other target features in the agricultural field. The rinse tank 120 may also be mounted on the agricultural vehicle 100 and may be fluidly coupled to the broadcast tank 111 and the SSP tank 112 and/or to the first fluid line(s) and/or to the second fluid line(s) such as for rinsing and/or direct injection.

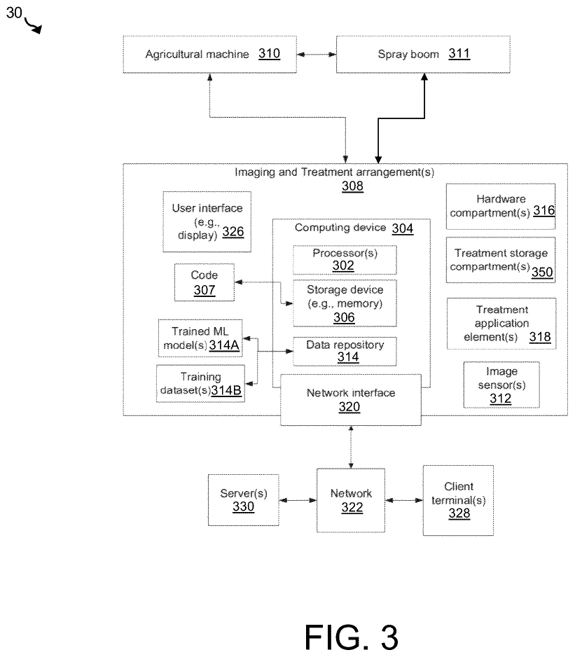

FIG. 3 is a block diagram of a spray system 30 for selectively applying a treatment to a target region according to one or more embodiments. Spray system 30 can be the same as dual-sprayer system 10 (FIG. 1) and/or dual-sprayer system 20 (FIG. 2).

The spray system 30 includes an agricultural machine 310, a spray boom 311, and one or more imaging and treatment arrangements 308. The agricultural machine 310 may be a tractor, an airplane, an off-road vehicle, or a drone. The spray boom 311 may be connected to the agricultural machine 310, and the imaging and treatment arrangements 308 may be connected to and/or mounted on the agricultural machine 310 or the spray boom 311. The spray boom 311 may be 10-50 meters in length. The imaging and treatment arrangements 308 may be evenly spaced every 1-3 meters (or another interval) along the length of the spray boom 311. Alternatively, the imaging and treatment arrangements 308 may be unevenly spaced (or a combination of evenly and unevenly spaced) along the length of the spray boom 311

Each imaging and treatment arrangement 308 includes a computing device 304 having a processor 302, a storage device 306, a data repository 314, and a network interface 320. The processor 302 executes code 307 stored in the storage device 306. The processor 302 may be implemented as a central processing unit (CPU), a graphics processing unit (GPU), a field programmable gate array (FPGA), a digital signal processor (DSP), and/or an application specific integrated circuit (ASIC). The processor 302 may include a single processor or multiple processors arranged for parallel processing, as clusters and/or as one or more multi-core processing devices.

The storage device 306 may include random-access memory (RAM), read-only memory (ROM), non-volatile memory, magnetic media, semiconductor memory devices, a hard drive, removable storage, and/or optical media such as DVD or CD-ROM. The data repository 314 stores a trained ML model 314A and a training dataset 314B. The data repository 314 may be implemented as a computer memory, a local hard-drive, a solid-state drive, solid-state memory, virtual storage, a removable storage unit, an optical disk, a storage device, a remote server, and/or a computing cloud. The trained ML model 314A may be configured to detect target features such as weeds within images captured by one or more image sensors 312 included in the imaging and treatment arrangement 308.

The image sensor 312 may include a color sensor, an RGB (red-green-blue) sensor such as CCD (charge-coupled device) and/or CMOS (complementary metal-oxide semiconductor) sensors, an infra-red (IR) sensor, a near-IR sensor, an ultraviolet sensor, a fluorescent sensor, a LIDAR (light detection and ranging) sensor, an NDVI (normalized difference vegetation index) sensor, a two-dimensional sensor, a three-dimensional sensor, and/or a multispectral sensor. The image sensor 312 may be arranged and positioned to capture images of a portion of the agricultural field located in front of the image sensor 312 and along a direction of motion of the agricultural machine 310.

The imaging and treatment arrangement 308 can include a user interface 326 for user interaction, a hardware compartment 316 for dynamic adaptation of liquid agricultural products, a treatment storage compartment 350 for storing treatment chemicals, and a treatment application element 318 for applying treatment to the field. The treatment application element 318 may include broadcast nozzles and selective-spot spray nozzles connected to the treatment storage compartment 350.

The network interface 320 connects the computing device 304 to a network 322, which enables communication with one or more servers 330 and one or more client terminals 328. The client terminals 328 may be used to remotely monitor the imaging and treatment arrangements 308 or change parameters thereof. The servers 330 may collect data from multiple imaging and treatment arrangements 308 for creating or updating training datasets for the trained ML model 314A. The network 322 may be implemented as the internet, a local area network, a wide-area network, a virtual network, a wireless network, a cellular network, a local bus, a point-to-point link, and/or combinations thereof. The network interface 320 may include a network interface card, an antenna, a wireless interface to connect to a wireless network, a physical interface for connecting to a cable for network connectivity, a virtual interface implemented in software, and/or network communication software providing higher layers of network connectivity.

In some cases, multiple imaging and treatment arrangements 308 may share a common computing device 304, a common storage device 306, and/or common processor 302. In such configurations, the shared computing resources may process images from multiple image sensors 312 and coordinate treatment application across multiple treatment application elements 318 along the spray boom 311.

The user interface 326 may include a mechanism for user interaction. The user interface 326 may include a touchscreen, a display, gesture activation devices, a keyboard, a mouse, and/or voice-activated software using speakers and a microphone. The user interface 326 may be used to enter data such as defining thresholds or sets of rules and/or to view data such as results of which treatment was applied to which portion of the field.

The client terminal 328 may be used to remotely monitor the imaging and treatment arrangement 308 and/or to remotely change parameters thereof. The client terminal 328 may include a smartphone, a mobile device, a laptop, a smart watch, a tablet, or a desktop computer. In some cases, the client terminal 328 may serve as the user interface by communicating with the computing device 304 and/or the server 330 over the network 322.

The server 330 may be used to remotely collect data from multiple imaging and treatment arrangements 308 of different agricultural machines. The server 330 may include a web server, a network node, a cloud server, a virtual server, or a virtual machine. The server 330 may create new training datasets and/or update existing training datasets for updating the trained ML model 314A with new images.

The trained ML model 314A may be configured to detect target features within images captured by the image sensor 312. The target features may include one or more weeds, one or more target pests or insects, and/or one or more target fungi. The trained ML model 314A may be configured to detect target features that are separate from a desired growth such as a crop. In some cases, the trained ML model 314A may be configured to detect one or more target agricultural crops in addition to or instead of weeds. One treatment storage compartment 350 may be selected from multiple treatment storage compartments according to an outcome of the trained ML model 314A for administration of a treatment by the treatment application element 318. Additional details regarding the trained ML model(s) 314A, the optional training dataset(s) 314B, and/or other components of system 30 are described in U.S. Pat. No. 11,393,049, titled “Machine Learning Models For Selecting Treatments For Treating an Agricultural Field,” which is hereby incorporated by reference.

System 30 may include a hardware component 316 associated with the agricultural machine 310 for dynamic adaption of the liquid agricultural products applied by the treatment application element(s) 318 according to dynamic orientation parameter(s) computed by analyzing an overlap region of images captured by image sensors 312, for example as described in U.S. Provisional Patent Application No. 63/082,500 , filed on Sep. 24, 2020, and/or in U.S. Pat. No. 11,393,049, which are hereby incorporated by reference. Additionally or alternatively, the hardware component 316 can include one or more chargers that can cause the specific liquid chemicals (e.g., sprayed by the selective-spot spray nozzles) and/or the general-application liquid chemicals (e.g., sprayed by the broadcast nozzles) to have an electrostatic charge. In some embodiments, the specific liquid chemicals and the non-specific liquid chemicals can have electrostatic charges having opposite polarities. For example, the specific liquid chemicals can have a positive electrostatic charge and the non-specific liquid chemicals have a negative electrostatic charge. Alternatively, the specific liquid chemicals can have a negative electrostatic charge and the non-specific liquid chemicals have a positive electrostatic charge.

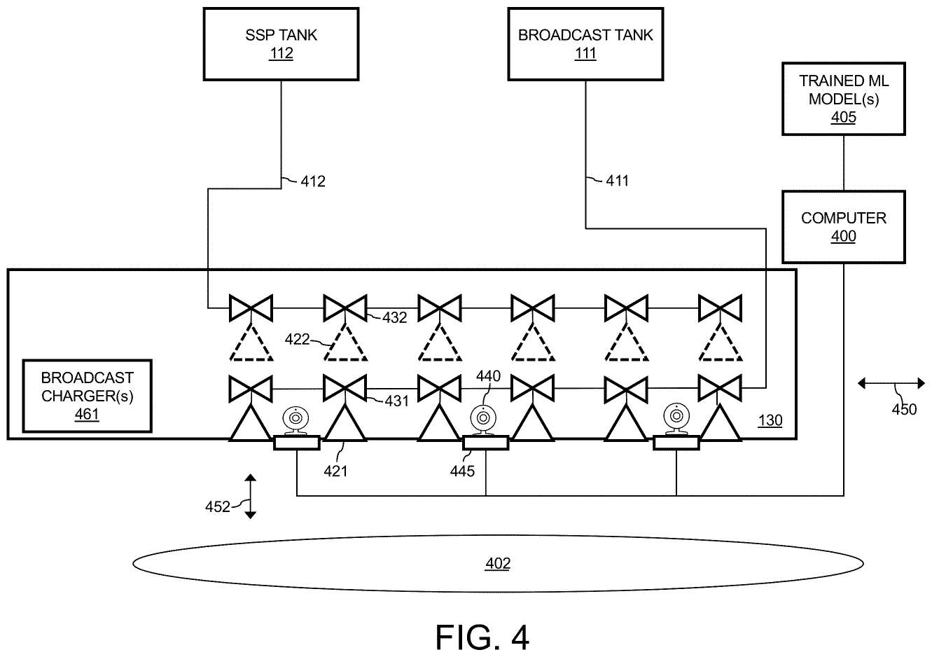

FIG. 4 is a simplified block diagram of fluid and electrical circuits for the dual-sprayer system 10, the dual-sprayer system 20, or the spray system 30 according to one or more embodiments. One or more broadcast fluid lines 411 fluidly couple the broadcast tank 111 to a plurality of broadcast nozzles 421 on the spray boom 130. One or more SSP fluid lines 412 fluidly couple the SSP tank 112 to a plurality of SSP nozzles 422 on the spray boom 130. The spray boom 130 extends along and parallel to a horizontal axis 450 where a direction of travel 452 of the spray system orthogonal (or approximately orthogonal) to the horizontal axis 450.

Electromechanically actuated broadcast valves 431 are located on and fluidly coupled to the broadcast fluid line(s) 411 between each broadcast nozzle 421 and the broadcast tank 111. Electromechanically actuated SSP valves 432 are located on and fluidly coupled to the SSP fluid line(s) 412 between each SSP nozzle 422 and the SSP tank 112. Each broadcast valve 431 and each SSP valve 432 may include a respective solenoid that allows the respective broadcast valve 431 or SSP valve 432 to open and close in response to control signals from a computer 400. In some cases, the SSP nozzles 422 may include the respective SSP valves 432. In some cases, the broadcast nozzles 421 may include the respective broadcast valves 431.

The broadcast nozzles 421 and the SSP nozzles 422 are configured and arranged on the spray boom 130 such that the broadcast nozzles 421 are located closer to a target spray region 402 than the SSP nozzles 422. Due to this difference in location, the general-application liquid agricultural product sprayed by the broadcast nozzles 421 reaches the target spray region 402 before the specific liquid agricultural product sprayed by the SSP nozzles 422 reaches the target spray region 402 (assuming both the broadcast nozzles 421 and the SSP nozzles 422 spray simultaneously).

The computer 400 is connected to or includes one or more trained ML models 405 and is in electrical communication with one or more cameras 440 and one or more lights 445 mounted on the spray boom 130. The cameras 440 capture images of the agricultural field, and the lights 445 provide illumination for the field. The lights 445 may include light-emitting diodes (LEDs) that provide light, such as flash illumination, for the agricultural field. The computer 400 receives images from the cameras 440 and feeds the images into the trained ML model(s) 405 to detect target features in the images. The trained ML model(s) 405 may be trained using first images that include the target features and second images that do not include the target features. The trained ML model(s) 405 can be the same as the trained ML model(s) 314A (FIG. 3).

A field-of-view (FOV) of each camera 440 and/or other image sensors is aligned with and corresponds to a position of one or more SSP nozzles 422 and to a position of one or more broadcast nozzles 421. In some cases, the cameras 440 may be separate from the broadcast nozzles 421 and the SSP nozzles 422. In some cases, the cameras 440 may be included or integrated with one of the spray nozzles, such as with the broadcast nozzles 421 or with the SSP nozzles 422.

One or more broadcast chargers 461 may be electrically coupled to one, some, or all of the broadcast nozzles 421 and/or to one or more of the broadcast fluid lines 411. The broadcast charger(s) 461 causes the general-application liquid agricultural product sprayed by the respective broadcast nozzles 421 to have an electrostatic charge. In some cases, droplets of the general-application liquid agricultural product sprayed by the broadcast nozzles 421 may have an electrostatic charge having a first polarity, such as positive or negative. In some cases, some of the droplets of the general-application liquid agricultural product may have a positive polarity and some of the droplets of the general-application liquid agricultural product may have a negative polarity.

The broadcast valves 431 coupled to the broadcast nozzles 421 may be opened and closed at a frequency and at a variable duty cycle to control an application rate of the general-application liquid agricultural product. The duty cycle of the broadcast valves 431 may be varied according to a speed of the agricultural vehicle 100, a height of the spray boom 130, and/or in response to imaging of the agricultural field and analysis or detection of target features such as weeds by the trained ML models 405.

The SSP valves 432 coupled to the SSP nozzles 422 may be opened and closed to selectively spray detected weeds. When the SSP valves 432 are opened, the SSP valves 432 may be repeatedly opened and closed at a frequency and at a variable duty cycle. The duty cycle of the SSP valves 432 may be varied according to the speed of the agricultural vehicle 100 and/or the height of the spray boom 130 to maintain a uniform or substantially uniform application rate of the specific liquid agricultural product. In some cases, the substantially uniform application rate may be within about 5% to about 10% of a target application rate.

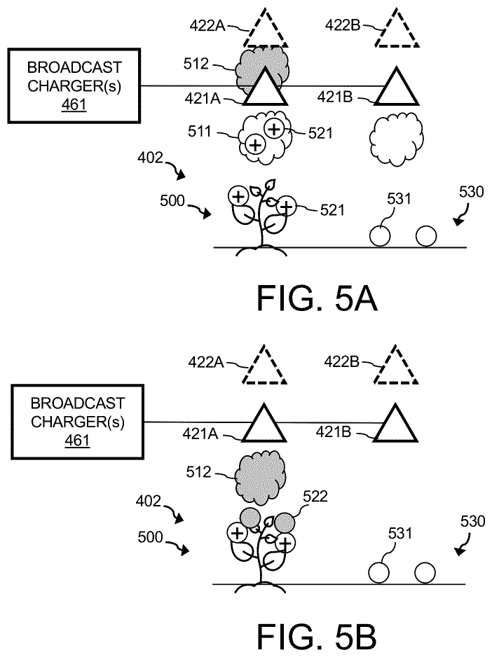

FIGS. 5A and 5B illustrate a time sequence of spraying using a first broadcast nozzle 421A, a second broadcast nozzle 421B, the broadcast charger(s) 461, a first SSP nozzle 422A, and a second SSP nozzle 422B (e.g., from the block diagram of FIG. 4). In FIG. 5A, the first broadcast nozzle 421A, the second broadcast nozzle 421B, and the first SSP nozzle 422A spray the target spray region 402. The first broadcast nozzle 421A and the first SSP nozzle 422A are spatially aligned with a target weed 500. The second SSP nozzle 422B may not be activated in some cases because no weeds are detected in a corresponding image by the trained ML model(s) 405.

With continued reference to FIG. 5A, the first broadcast nozzle 421A and the second broadcast nozzle 421B are located closer to the target spray region 402 than the first SSP nozzle 422A and the second SSP nozzle 422B such that a broadcast spray 511 produced by the first broadcast nozzle 421A and the second broadcast nozzle 421B reaches the target spray region 402 including the target weed 500 before an SSP spray 512 produced by the first SSP nozzle 422A. The broadcast spray 511 from the first broadcast nozzle 421A includes charged broadcast droplets 521 produced using the broadcast charger(s) 461. The first broadcast nozzle 421A sprays the charged broadcast droplets 521 onto the target weed 500. The second broadcast nozzle 421B sprays neutral droplets 531 onto a ground 530 or another portion of the agricultural field that does not include weeds.

As further shown in FIG. 5B, the SSP spray 512 reaches the target weed 500 and the SSP droplets 522 in the SSP spray 512 are electrostatically attracted to the charged broadcast droplets 521 on the target weed 500. The charged broadcast droplets 521 on the ground 530, sprayed by the second broadcast nozzle 421B, rapidly become electrostatically neutral droplets 531 due to contact of the charged broadcast droplets 521 with the ground 530. The SSP droplets 522 include electrically polar water molecules that are electrostatically attracted to the charged broadcast droplets 521 on the target weed 500. The SSP droplets 522 are not electrostatically attracted to the neutral droplets 531 on the ground 530, thus increasing selectivity and effectiveness of the specific liquid agricultural product in the SSP spray 512 compared to when the broadcast spray 511 is not electrostatically charged.

With continued reference to FIGS. 5A and 5B, the charged broadcast droplets 521 may have a negative polarity or a positive polarity. In some cases, some of the charged broadcast droplets 521 may have a negative polarity and some of the charged broadcast droplets 521 may have a positive polarity.

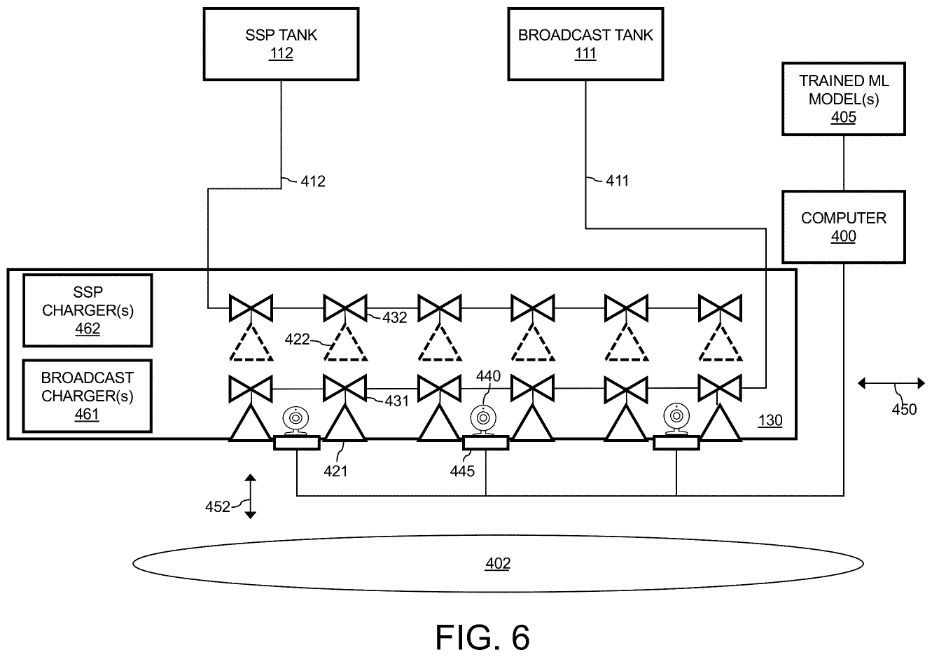

FIG. 6 is a simplified block diagram of fluid and electrical circuits for a sprayer system 10, 20, 30 according to one or more alternative embodiments. The block diagram shown in FIG. 6 is the same or similar to that shown in FIG. 4 except that the block diagram shown in FIG. 6 includes one or more SSP chargers 462. The SSP charger(s) 462 may be electrically coupled to one, some, or all of the SSP nozzles 422 and/or to one or more of the SSP fluid line(s) 412. The SSP charger(s) 462 causes the specific liquid agricultural product sprayed by the respective SSP nozzles 422 to have an electrostatic charge.

The broadcast charger(s) 461 and the SSP charger(s) 462 are configured to produce electrostatic charges having opposite polarities. In some cases, the broadcast charger(s) 461 may cause the droplets of the general-application liquid agricultural product to have a positive charge and the SSP charger(s) 462 may cause the droplets of the specific liquid agricultural product to have a negative charge. In some cases, the SSP charger(s) 462 may cause the droplets of the specific liquid agricultural product to have a positive charge and the broadcast charger(s) 461 may cause the droplets of the general-application liquid agricultural product to have a negative charge.

As further shown in FIG. 6, the broadcast tank 111 is fluidly coupled to the plurality of broadcast nozzles 421 on the spray boom 130 via the broadcast fluid line 411. The SSP tank 112 is fluidly coupled to the plurality of SSP nozzles 422 on the spray boom 130 via the SSP fluid line 412. The broadcast valves 431 are positioned on the broadcast fluid line 411 between each broadcast nozzle 421 and the broadcast tank 111. The SSP valves 432 are positioned on the SSP fluid line 412 between each SSP nozzle 422 and the SSP tank 112. The broadcast nozzles 421 are located closer to the target spray region 402 than the SSP nozzles 422.

With continued reference to FIG. 6, the computer 400 is connected to and/or includes the trained ML model(s) 405 and controls operation of the dual-sprayer system (e.g., the dual-sprayer 10, the dual-sprayer system 20, or the spray system 30). The cameras 440 and the lights 445 are in electrical communication with the computer 400 to coordinate timing and frequency of image capture and illumination. The computer 400 receives images from the cameras 440 and feeds the images into the trained ML models 405 to detect target features in the images. When a target feature such as the target weed 500 is detected, the computer 400 may activate the broadcast charger(s) 461 and the SSP charger(s) 462 such that charged droplets from the SSP nozzles 422 are electrostatically attracted to charged droplets from the broadcast nozzles 421 on the target weed 500.

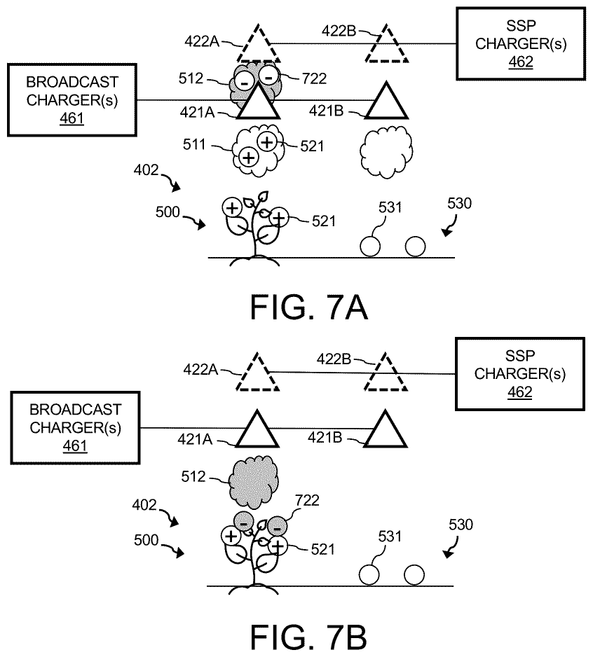

FIGS. 7A and 7B illustrate a time sequence of spraying using praying using the first broadcast nozzle 421A, the second broadcast nozzle 421B, the broadcast charger(s) 461, the first SSP nozzle 422A, the second SSP nozzle 422B, and the SSP charger(s) 462 (e.g., from the block diagram of FIG. 6). The time sequence shown in FIGS. 7A and 7B is similar to that shown in FIGS. 5A and 5B except that in FIGS. 7A and 7B the SSP spray 512 includes charged SSP droplets 722. The charged SSP droplets 722 have an opposite electrostatic charge than the charged broadcast droplets 521.

With continued reference to FIG. 7A, the first broadcast nozzle 421A and the second broadcast nozzle 421B are positioned closer to the target spray region 402 than the first SSP nozzle 422A and the second SSP nozzle 422B. The broadcast charger(s) 461 is connected to the first broadcast nozzle 421A and the second broadcast nozzle 421B, while the SSP charger(s) 462 is connected to the first SSP nozzle 422A and the second SSP nozzle 422B. The target weed 500 is located within the target spray region 402. The first broadcast nozzle 421A produces a broadcast spray 511 containing the charged broadcast droplets 521 that are applied to the target weed 500. The first SSP nozzle 422A produces an SSP spray 512 containing the charged SSP droplets 722 that are directed toward the target weed 500. The neutral droplets 531 are shown on the ground 530 in a region where no weeds are detected.

As further shown in FIG. 7B, the charged SSP droplets 722 in the SSP spray 512 are electrostatically attracted to the oppositely charged broadcast droplets 521 on the target weed 500. The electrostatic attraction between the charged SSP droplets 722 and the charged broadcast droplets 521 increases selectivity and effectiveness of the specific liquid agricultural product in the SSP spray 512 compared to when the SSP spray 512 and the broadcast spray 511 are not electrostatically charged.

With continued reference to FIGS. 7A and 7B, the charged broadcast droplets 521 may have a positive polarity and the charged SSP droplets 722 may have a negative polarity. In some cases, the charged broadcast droplets 521 may have a negative polarity and the charged SSP droplets 722 may have a positive polarity. The neutral droplets 531 remain on the ground 530 and do not attract the charged SSP droplets 722 because the neutral droplets 531 have become electrostatically neutral due to contact with the ground 530.

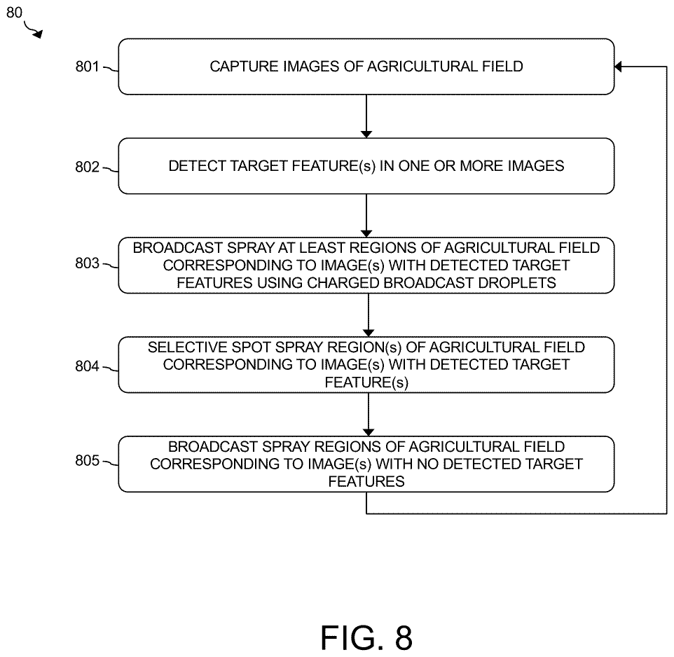

FIG. 8 is a flow chart of a method 80 for spraying an agricultural field using charged broadcast droplets according to one or more embodiments.

In step 801, images of respective regions of the agricultural field are captured using the cameras 440 or other image sensors mounted on the spray boom 130. The respective regions are located in front of the spray boom 130 along the direction of travel 452 and are located laterally from each other along or parallel to the horizontal axis 450. The spray boom 130 may be pushed or pulled by the agricultural vehicle 100. The cameras 440 may be separate from the broadcast nozzles 421 and the SSP nozzles 422 or may be included or integrated with one of the spray nozzles.

In step 802, target features are detected in one or more of the images. The target features may be detected using the trained ML model(s) 314A, 405. In some cases, the target features may include or may be an undesired growth such as one or more weeds.

In step 803, at least the regions of the agricultural field in which at least one target feature is detected (e.g., in the image(s) by an ML model) are broadcast sprayed with residual herbicides using the broadcast nozzles 421. The broadcast charger(s) 461 electrostatically charges the residual herbicides such that the charged broadcast droplets 521 are generally applied to the agricultural field including the target weed 500. The broadcast spraying may be performed by transitioning the respective broadcast valves 431 for the broadcast nozzles 421 from an inactive state to an active state. In the active state, the broadcast valves 431 are opened and closed at a frequency and a variable duty cycle. In one or more embodiments, the agricultural field is generally sprayed with residual herbicides that includes charged broadcast droplets 521.

In step 804, the regions of the agricultural field in which at least one target feature is detected are selectively spot sprayed with non-residual herbicides. The selective spot spraying may be performed by transitioning the respective SSP valves 432 for the SSP nozzles 422 from an inactive state to an active state. In the active state, the SSP valves 432 are opened and closed at a frequency and a variable duty cycle. The SSP droplets 522 are electrostatically attracted to the charged broadcast droplets 521. In some cases, the SSP charger(s) 462 may electrostatically charge the non-residual herbicides such that the charged SSP droplets 722 are applied to the target weed 500. The charged SSP droplets 722 are electrostatically attracted to the charged broadcast droplets 521 on the target weed.

In step 805, the regions of the agricultural field in which no target features are detected are broadcast sprayed with one or more residual herbicides using the broadcast nozzles 421. The broadcast spraying may be performed by transitioning the respective broadcast valves 431 for the broadcast nozzles 421 from an inactive state to an active state. In one or more embodiments, the broadcast charger(s) 461 does not electrostatically charge the residual herbicides applied to the regions of the agricultural field in which no target features are detected. Alternatively, the broadcast charger(s) 461 can electrostatically charge the residual herbicides applied to the regions of the agricultural field in which no target features are detected, such that all electrostatically charged residual herbicide droplets are applied generally to some or all regions of the agricultural field regardless of whether target feature(s) (e.g., target weed(s) is/are detected in such regions.

In some cases, one or more regions of the agricultural field may be broadcast sprayed at an increased application rate compared to a default application rate using the broadcast nozzles 421 and the respective broadcast valves 431. The regions broadcast sprayed at the increased application rate may include neighboring regions that are adjacent to the regions where target features and/or a cluster of the target features are detected. The regions broadcast sprayed at the increased application rate may include regions having a high weeds concentration in prior years based on historical weed data. A high weeds concentration may be above a threshold value. Broadcast spraying at the increased application rate may include operating the respective broadcast nozzles 421 at a higher duty cycle compared to a default duty cycle.

After step 805, the method 80 can return to step 801, allowing the process to repeat in a loop as the agricultural vehicle (e.g., agricultural vehicle 100 (FIGS. 1, 2) passes over the agricultural field.

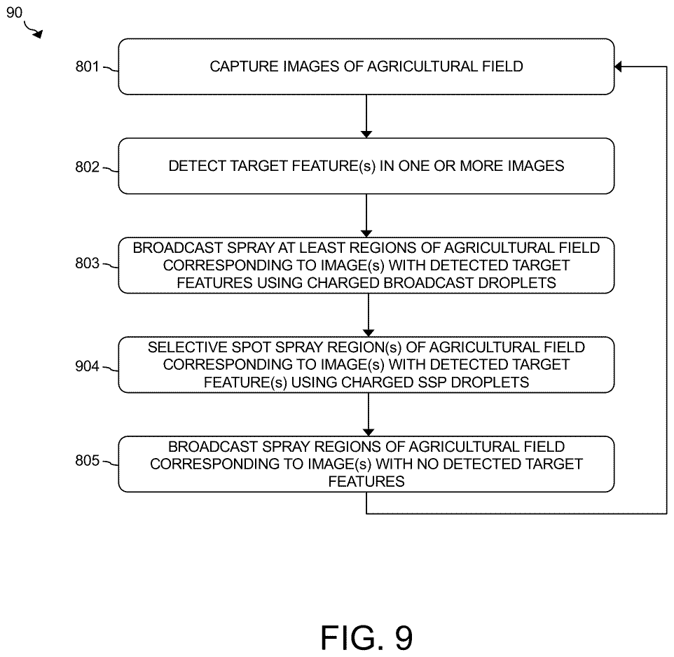

FIG. 9 is a flow chart of a method 90 for spraying an agricultural field using charged broadcast droplets according to one or more embodiments. Method 90 is the same as method 80 (FIG. 8) except that method 90 includes step 904 instead of step 804 in method 80. In step 904 the regions of the agricultural field in which at least one target feature is detected are selectively spot sprayed with non-residual herbicides. The SSP charger(s) 462 electrostatically charges the non-residual herbicides such that the charged SSP droplets 722 are applied to the target weed 500. The charged SSP droplets 722 can have the opposite polarity as the charged broadcast droplets 521 such that the charged SSP droplets 722 are electrostatically attracted to the charged broadcast droplets 521 on the target weed.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. An agricultural sprayer, comprising:
a spray boom configured to be attached to an agricultural vehicle;
one or more broadcast nozzles mounted on the spray boom and configured to spray a residual herbicide onto an agricultural field;
one or more selective-spot spray nozzles mounted on the spray boom and configured to spray a non-residual herbicide onto the agricultural field;
one or more broadcast chargers electrically coupled to the one or more broadcast nozzles, the one or more broadcast chargers configured to cause the residual herbicide sprayed by the one or more broadcast nozzles to have an electrostatic charge such that charged broadcast droplets are applied to a target weed in the agricultural field;
one or more cameras mounted on the spray boom and configured to capture images of the agricultural field; and
a computing device configured to:
receive the images from the one or more cameras;
detect the target weed in one or more of the images using a trained machine learning model;
activate the one or more broadcast nozzles to spray the charged broadcast droplets onto at least a region of the agricultural field that includes the target weed; and
selectively activate, in response to detecting the target weed, the one or more selective-spot spray nozzles to spray droplets of the non-residual herbicide onto the target weed, wherein the droplets of the non-residual herbicide are electrostatically attracted to the charged broadcast droplets on the target weed.

2. The agricultural sprayer of claim 1, wherein the one or more broadcast nozzles are located closer to a target spray region of the agricultural field than the one or more selective-spot spray nozzles such that the charged broadcast droplets reach the target weed before the droplets of the non-residual herbicide reach the target weed.

3. The agricultural sprayer of claim 1, wherein the charged broadcast droplets have a positive polarity.

4. The agricultural sprayer of claim 1, wherein the charged broadcast droplets have a negative polarity.

5. The agricultural sprayer of claim 1, further comprising one or more selective-spot spray chargers electrically coupled to the one or more selective-spot spray nozzles, the one or more selective-spot spray chargers configured to cause the non-residual herbicide sprayed by the one or more selective-spot spray nozzles to have an electrostatic charge such that charged selective-spot spray droplets are applied to the target weed, wherein the charged selective-spot spray droplets are electrostatically attracted to the charged broadcast droplets on the target weed.

6. The agricultural sprayer of claim 5, wherein the charged broadcast droplets and the charged selective-spot spray droplets have opposite polarities.

7. The agricultural sprayer of claim 6, wherein the charged broadcast droplets have a positive polarity and the charged selective-spot spray droplets have a negative polarity.

8. The agricultural sprayer of claim 6, wherein the charged broadcast droplets have a negative polarity and the charged selective-spot spray droplets have a positive polarity.

9. The agricultural sprayer of claim 1, wherein the residual herbicide comprises s-metolachlor, acetochlor, pyroxasulfone, atrazine, and/or mesotrione.

10. The agricultural sprayer of claim 1, wherein the non-residual herbicide comprises glyphosate, glufosinate, and/or 2,4-dichlorophenoxyacetic acid.

11. The agricultural sprayer of claim 1, wherein the computing device is further configured to activate the one or more broadcast nozzles to spray the residual herbicide onto regions of the agricultural field where no target weeds are detected, and wherein the one or more broadcast chargers do not electrostatically charge the residual herbicide applied to the regions of the agricultural field where no target weeds are detected.

12. A method for spraying an agricultural field, comprising:
capturing images of respective regions of the agricultural field using one or more cameras mounted on a spray boom;
detecting a target weed in one or more of the images using a trained machine learning model;
broadcast spraying at least the respective regions of the agricultural field in which the target weed is detected, with a residual herbicide using one or more broadcast nozzles mounted on the spray boom, wherein one or more broadcast chargers electrostatically charge the residual herbicide such that charged broadcast droplets are applied to the target weed; and
selective spot spraying the respective regions of the agricultural field in which the target weed is detected with a non-residual herbicide using one or more selective-spot spray nozzles mounted on the spray boom, wherein droplets of the non-residual herbicide are electrostatically attracted to the charged broadcast droplets on the target weed.

13. The method of claim 12, wherein the one or more broadcast nozzles are located closer to a target spray region of the agricultural field than the one or more selective-spot spray nozzles such that the charged broadcast droplets reach the target weed before the droplets of the non-residual herbicide reach the target weed.

14. The method of claim 12, further comprising electrostatically charging the non-residual herbicide using one or more selective-spot spray chargers such that charged selective-spot spray droplets are applied to the target weed, wherein the charged selective-spot spray droplets are electrostatically attracted to the charged broadcast droplets on the target weed.

15. The method of claim 14, wherein the charged broadcast droplets and the charged selective-spot spray droplets have opposite polarities.

16. The method of claim 12, further comprising broadcast spraying regions of the agricultural field in which no target weeds are detected with the residual herbicide using the one or more broadcast nozzles, wherein the one or more broadcast chargers do not electrostatically charge the residual herbicide applied to the regions of the agricultural field in which no target weeds are detected.

17. The method of claim 16, further comprising broadcast spraying neighboring regions adjacent to the respective regions in which the target weed is detected at an increased application rate compared to a default application rate.

18. A non-transitory computer-readable medium storing computer-readable instructions that, when executed by one or more processors, cause the one or more processors to:
receive images of an agricultural field from one or more cameras mounted on a spray boom;
detect a target weed in one or more of the images using a trained machine learning model;
activate one or more broadcast nozzles mounted on the spray boom to spray charged broadcast droplets of a residual herbicide onto at least a region of agricultural field that includes the target weed, wherein the charged broadcast droplets are electrostatically charged by one or more broadcast chargers electrically coupled to the one or more broadcast nozzles; and
selectively activate, in response to detecting the target weed, one or more selective-spot spray nozzles mounted on the spray boom to spray droplets of a non-residual herbicide onto the target weed, wherein the droplets of the non-residual herbicide are electrostatically attracted to the charged broadcast droplets on the target weed.

19. The non-transitory computer-readable medium of claim 18, wherein the computer-readable instructions, when executed by one or more processors, further cause the one or more processors to activate one or more selective-spot spray chargers electrically coupled to the one or more selective-spot spray nozzles to electrostatically charge the non-residual herbicide such that charged selective-spot spray droplets are applied to the target weed, wherein the charged selective-spot spray droplets are electrostatically attracted to the charged broadcast droplets on the target weed, and wherein the charged broadcast droplets and the charged selective-spot spray droplets have opposite polarities.

20. The non-transitory computer-readable medium of claim 18, wherein the computer-readable instructions, when executed by one or more processors, further cause the one or more processors to activate the one or more broadcast nozzles to spray the residual herbicide onto regions of the agricultural field where no target weeds are detected, and wherein the one or more broadcast chargers do not electrostatically charge the residual herbicide applied to the regions of the agricultural field where no target weeds are detected.
